(19) United States
(12) Patent Application Publication
(10) Pub. No.: US 2004/0248720 A1
(43) Pub. Date: Dec. 9, 2004

(54) Container, device and method for manufacturing thereof

(76) Inventor: Ake Rosen, Rydeback (SE)

Correspondence Address: BIRCH STEWART KOLASCH & BIRCH, PO BOX 747, FALLS CHURCH, VA, 22040-0747, US

(21) Appl. No.: 10/494,630

(22) PCT Filed: Aug. 29, 2002
(86) PCT No.: PCT/SE02/01533

(30) Foreign Application Priority Data
Nov. 14, 2001 (SE) 0103775-3

(51) Int. Cl. B31B 1/14

(52) U.S. Cl. 493/356

(57) ABSTRACT

A container for liquid contents, comprising a compartment (4) which is defined by flexible walls (2, 3) and whose volume is dependent on the relative position of the walls (2, 3). The walls (2, 3) have rim portions which engage each other and along which the walls (2, 3) are joined with each other in a common connecting portion (6). The container is characterised in that the walls (2, 3) are made in one piece, which is folded to form said walls (2, 3), and that the walls (2, 3) along said rim portions are sealed to form said connecting portion (6). The present invention also concerns a method and a device for producing such a container.

### FIELD OF THE INVENTION

The present invention relates to a container as well as a method and a device for producing the same. More specifically, the invention concerns a container for liquid contents, comprising a compartment which is defined by flexible walls and whose volume is dependent on the relative position of the walls, the walls having rim portions which engage each other and along which the walls are joined with each other in a common connecting portion, and a corresponding method and device for producing such a container.

### BACKGROUND ART

Containers of the type described by way of introduction are usually referred to as collapsible containers, which are advantageous since the compartment defined by the walls of the container reduces its volume as the liquid contents are being poured out of the container. This reduces the air exposure of the contents, which has a positive effect on the keeping qualities of the contents. The containers can also be produced at an advantageously low cost and can also be adapted to aseptic filling.

Containers of the above type are known from, for instance, WO99/41155.

With a view to producing the containers described in WO99/41155, three material webs are joined, which are then sealed together in connecting portions. Each connecting portion has an extent which essentially corresponds to the shape of a finished container. Subsequently a web of succeeding containers is punched, along said connecting portions, from the material webs joined together. Each container forms a container which before filling is in a flat, empty and sealed state. The container has two opposite side walls and a bottom wall, which walls are obtained from one material web each.

The thus produced containers exhibit a number of advantages. It is especially preferred to produce the containers of a container material comprising a filler of mineral material and a binder of polyolefin. This results in a container of a collapsible type, which in spite of its small material thickness has the requisite rigidity to provide an environment-friendly as well as user-friendly container.

A problem associated with this type of container relates to the actual production process. In fact, the containers usually have a decorative print on their outside, and as a rule this-print is applied to the webs of material, from which said containers are to be produced. It will be appreciated that the different webs of material must be joined with great accuracy to ensure the requisite pattern alignment.

Moreover, sealing together the webs of material in said connecting portions requires that a sealing tool be pressed down to the joined webs of material. During the actual sealing procedure, the web of material must be stopped, thus causing intermittent operation which is unfavourably time-consuming.

There is thus a need for a container of this type, which can be produced at a higher production rate and which allows a reduced need for pattern alignment.

### SUMMARY OF THE INVENTION

In view of that stated above, it is a first object of the present invention to provide an improved method and device for producing containers of the type described above. Both the method and the device should preferably allow production of containers at an improved production rate while the need for pattern alignment is reduced.

Another object is to provide such an improved container which preferably can be produced at a high production rate with a reduced need for pattern alignment.

According to the present invention, these objects, as well as other objects that will be evident from the following description, are achieved by a container having the features stated in claim 1 as well as a method and a device for producing containers having the features stated in claim 3 and claim 9 respectively.

Preferred embodiments of the container are defined in claim 2, preferred embodiments of the method are defined in claims 4-8, and preferred embodiments of the device are defined in claims 10-17.

More specifically, according to the present invention a container for liquid contents is provided, comprising a compartment which is defined by flexible walls and whose volume is dependent on the relative position of the walls, the walls having rim portions which engage each other and along which the walls are joined with each other in a common connecting portion, which container is characterised in that the walls are made in one piece, which is folded to form said walls, and that the walls along said rim portions are sealed to form said connecting portion.

As a result, a container is provided, which can be produced in a continuous process while the need for pattern alignment is reduced. Since the container is made in one piece, which is folded to form its walls, the need of accurately joining and sealing together a plurality of separate pieces is eliminated.

According to a preferred embodiment of the inventive container, the piece is folded to form a container comprising two opposite side walls and a bottom wall, by means of which the side walls are joined with each other.

According to the present invention, also a method for producing containers is provided, which each have a compartment which is defined by flexible walls and whose volume is dependent on the relative position of the walls, which method if characterised by the steps of converting a web-shaped container material into a longitudinally folded web having at least one fold along one long side of the folded web, sealing together opposing surfaces of the web along succeeding connecting portions, each connecting portion forming a curve having a starting point and an end point along said at least one fold and being of an extent which essentially corresponds to the shape of a finished container.

This results in a method, which allows production of containers with a reduced need for pattern alignment. By a web-shaped container material being folded to form the folded web, the need of joining separate webs of material is eliminated.

According to a preferred embodiment of the inventive method, the opposing surfaces are sealed in a continuous heat sealing process. Alternatively, the opposing surfaces can be sealed together in a continuous ultrasonic sealing process. The continuous process allows production of containers at a relatively high production rate.

According to another preferred embodiment, the method comprises the step of removing the finished containers from the web along said connecting portions, the containers preferably being removed from the web in such a manner that the succeeding containers are interconnected to form a web of containers. This results in a web of containers which in a rational way can be used as container blanks in a filling machine.

According to yet another preferred embodiment, the step of converting the web-shaped container material into a longitudinally folded web comprises the measure of making a W-folded web with two folds which extend along said one long side of the folded web, whereby the web obtains two opposite lateral portions and a central portion folded in two, which connects the two lateral portions with each other, each container obtaining a side wall from the respective lateral portions and a bottom wall from the central portion.

Finally, according to the present invention a device for producing containers is provided, which each have a compartment defined by flexible walls and whose volume is dependent on the relative position of the walls, which device is characterised by a folding station for converting a web-shaped container material into a longitudinally folded web having at least one fold along one long side of the folded web, and a sealing station which is adapted to seal together opposing surfaces of the web along succeeding connecting portions, which each form a curve having a starting point and an end point along said at least one fold and being of an extent which essentially corresponds to the shape of a finished container.

As a result, a device is provided, which allows production of containers from a single web-shaped container material, thereby reducing the need for pattern alignment.

According to a preferred embodiment of the inventive device, said folding station is adapted to convert said container material into a longitudinally W-folded web with two folds which extend along said one said long side of the folded web. As a result, production of containers is allowed, which each have a compartment defined by two opposite side walls and a bottom wall.

The sealing station is preferably adapted to seal together the opposing surfaces of the web along succeeding connecting portions in a continuous process. The sealing station can to this end comprise a cylindrical profile means, on whose circumferential surface at least one projecting profile is arranged, which is of an extent corresponding to the shape of a connecting portion, a nip means which forms a nip with said profile means, said at least one profile of the profile means being adapted, when inserting the folded web into said nip, to engage with the folded web and make the same abut against the nip means to form said connecting portions.

According to one embodiment, the sealing station comprises a heating means for providing heat sealing in connection with the profile's engagement with said folded web.

Alternatively, the nip means may comprise an ultrasonic means for providing ultrasonic sealing in connection with the profile's engagement with said folded web.

Preferred embodiments of the present invention will now be described by way of example with reference to accompanying drawings.

### BRIEF DESCRIPTION OF THE DRAWINGS

FIG. 1 is a top plan view of a preferred embodiment of an inventive container.

FIG. 2 is a cross-sectional view along line II-II in FIG. 1.

FIG. 3 is a schematic perspective view of a first preferred embodiment of an inventive device for producing containers.

FIG. 4 is schematic perspective view of a second preferred embodiment of an inventive device for producing containers.

FIG. 5 is a schematic perspective view of a third preferred embodiment of an inventive device for producing containers.

### DESCRIPTION OF EMBODIMENTS

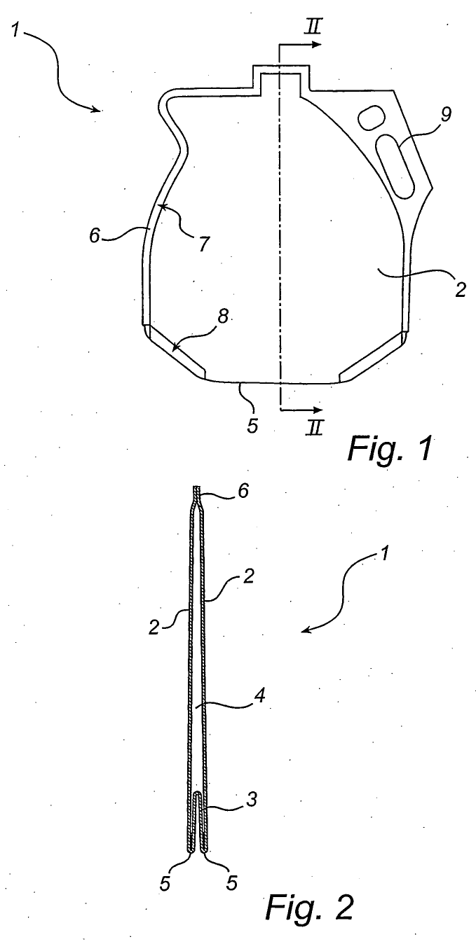

FIGS. 1 and 2, to which reference is now made, illustrate a preferred embodiment of an inventive container 1.

The container 1, which before filling is in an empty, flat and sealed state, comprises a compartment 4 which is defined by flexible walls 2, 3 and whose volume is dependent on the relative position of the walls 2, 3.

The walls 2, 3 of the container 1 comprise more specifically two opposite side walls 2 and a bottom wall 3, which walls 2, 3 are made in one piece and delimited from each other by means of folds 5. The walls 2, 3 have rim portions engaging each other, along which the walls 2, 3 are sealed together in a common connecting portion 6. More specifically, the connecting portion 6 comprises an upper connecting portion 7, in which rim portions of the side walls 2 are interconnected, and a lower connecting portion 8, in which lower parts of the rim portions of the side walls 2 are connected with rim portions of the bottom wall 3.

The bottom wall 3 separating the two side walls 2 from each other is, in the flat state of the container 1, in a state folded in two, which is clearly to be seen in FIG. 2. The cross-section of the empty and flat container 1 as shown in FIG. 2 illustrates the side walls 2 slightly separated for better clarity.

In connection with filling of the container 1, the bottom wall 3 folded in two is straightened out and forms a stable bottom of the container 1.

The Figures also show that the container 1 is preferably formed with a carrying means 9, which makes the container 1 more user-friendly.

The inventive container 1 is preferably made of a laminated container material comprising a core layer with a filler of mineral material and a binder of polyolefin. It is preferred for the container material to have a sealing layer on its inside-forming surface, which sealing layer, in relation to the other layers, has a lower melting point. This means that during the process of sealing together the walls 2, 3 to make said connecting portion 6 it will be easy to control the sealing process by suitable control of the sealing temperature.

A number of preferred embodiments of devices for producing containers will be described in the following. Components having a similar function have been given the same reference numerals throughout the description.

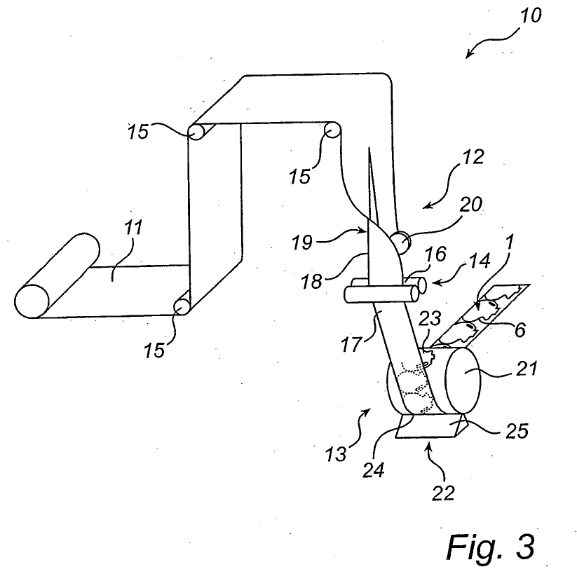

FIG. 3, to which reference is now made, illustrates a first preferred embodiment of an inventive device 10 for producing the container 1 shown in FIGS. 1-2 from a web-shaped container material 11, which in the shown embodiment is supplied as a roll.

The device 10 comprises a folding station 12 and a sealing station 13.

The folding station 12 comprises a nip-forming pair of rollers 14 and an engaging means (not shown).

The container material 11 is passed via deflecting rollers 15 to a nip 16 of the pair of rollers 14, which is arranged perpendicular to the container material 11. At the same time the material 11 is folded while the engaging means engage the same to form a longitudinally W-folded web 17 with two folds 18 along one long side 19 of the folded web 17. Consequently, it is a thus W-folded web 17 that is introduced into said nip 16, a guiding wheel 20 ensuring that the W folding is continuously uniform.

The W-folded web 17 allows production of containers 1 of the type shown with reference to FIGS. 1 and 2, which consequently comprises two opposite side walls 2 and a bottom wall 3. However, it will be appreciated the folding station can be arranged in other ways. If a container is to comprise only two opposite side walls, it is possible, for instance, to arrange the folding station for converting the container material into a longitudinally V-folded web with only one fold along one long side of the folded web.

The sealing station 13 comprises a cylindrical profile means 21 and a nip means 22.

The profile means 21 carries on its circumferential surface a plurality of profiles 23, which each are of an extent that essentially corresponds to the connecting portion 6 of the finished container 1.

The nip means 22 forms together with said profile means 21 a nip 24 and comprises an ultrasonic means 25.

The W-folded web 17 connects to the periphery of the profile means 21 and is passed on into said nip 24, in which the profile 23 of the profile means 21 engages the web 17 and presses the same against the nip means 22 made in the form of an ultrasonic means 25. The profile means 21 is rotated at such a speed that the relative speed of the same to the folded web 17 is essentially zero.

The ultrasonic means 25 is adapted to generate high-frequency energy which is focused in the areas where two surfaces make contact with each other. The sealing effect is a function of the frequency of the high-frequency energy and of the power by means of which the surfaces abut against each other. The energy will thus be focused in areas along which the profile 23 engages the web 17, whereby opposing surfaces of the folded web 17 are sealed together in succeeding connecting portions 16.

The profiles 23 of the profile means 21 are designed so that each connecting portion 16 on said web 17 forms a curve which has a starting point and an end point along said folds 18 of the folded web 17 and is of an extent which essentially corresponds to the shape of the finished container 1.

The device 10 preferably also comprises a station (not shown) for punching the containers 1 from the web 17 along said connecting portions 16, the containers 1 being advantageously removed from the web 17 so that two succeeding containers 1 are interconnected. This results in a web of containers 1, which in a rational manner can be used as container blanks in a suitably designed filling machine.

It will be appreciated that the inventive device for producing containers is not limited to the embodiment described above.

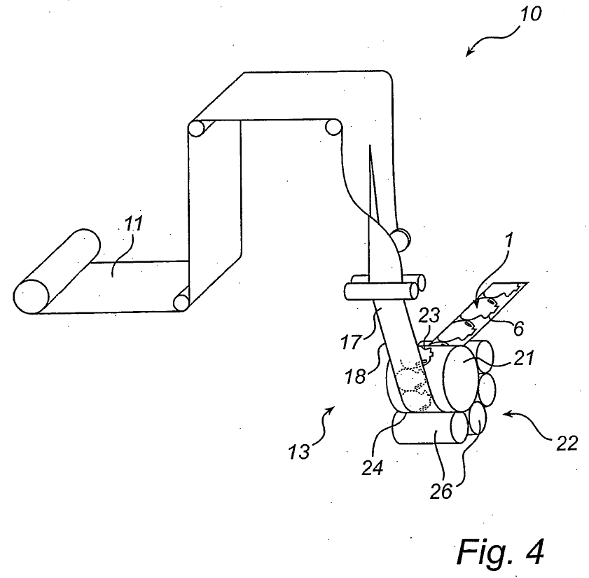

FIG. 4, to which reference is now made, illustrates a second preferred embodiment of an inventive device 10, which differs from the above device by the manner in which the sealing station 13 is designed.

The sealing station 13 comprises also in this embodiment a profile means 21, on the circumferential surface of which a plurality of profiles 23 are arranged, which each are of an extent which essentially corresponds to the connecting portion 6 of the finished container 1.

The nip means 22, however, is formed of a plurality of roller means 26, which each form a nip 24 with the profile means 21.

Moreover the sealing station 13 comprises a heating means (not shown), which can be adapted to heat the profile means 21 and/or the roller means 26 to a temperature necessary for sealing.

The W-folded web 17 passed to the sealing station 13 is inserted in turn into said nips 24. In each of the nips 24, the profile 23 of the profile means 21 engages the web 17 and presses the same against the respective roller means 26, the heating means ensuring that sealing takes place between opposing surfaces of the folded web 17 along the extent of the profile 23 to form succeeding connecting portions 6 which each form a curve having a starting point and an end point along said folds 18 of the folded web 17 and an extent which essentially corresponds to the shape of the finished container 1.

The use of a plurality of roller means 26 ensures that a sufficiently strong seal is provided along the connecting portions 6.

As mentioned above, the container material 11 advantageously comprises a sealing layer on its inside-forming surface, which sealing layer has a relatively low melting point, thereby ensuring that sealing only takes place where sealing is desired.

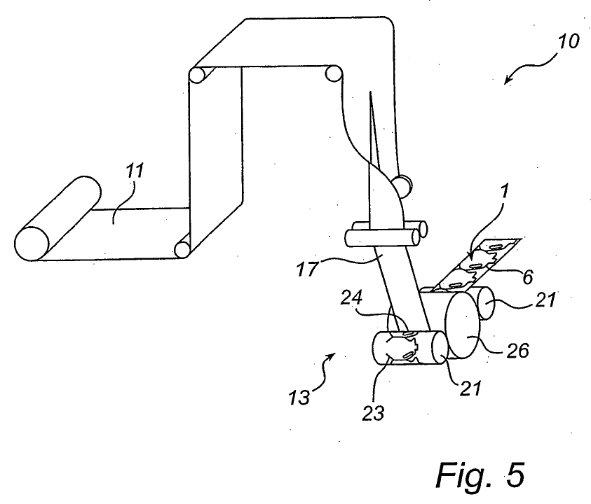

FIG. 5, to which reference is now made, illustrates another preferred embodiment of an inventive device 10 for producing containers 1.

This embodiment differs from the embodiment described with reference to FIG. 4 by the sealing station 13 comprising a roller means 26 and two profile means 21. On the circumferential surface of each profile means 21 there are arranged a plurality of projecting profiles 23, which each are of an extent that essentially corresponds to the shape of the connecting portion 6 of the finished container 1.

The roller means 26 abuts against the two profile means 21 and thus forms a nip 24 with the respective profile means 21.

The folded web 17 is thus passed to the nip 24 between the roller means 26 and a first of the profile means 21 and then to the nip 24 between the roller means 26 and a second of the profile means 21. In each nip 24, the profile 23 of each profile means 21 engages the web 17 and presses the same against the roller means 26 for sealing together opposing surfaces of the web 17 along succeeding connecting portions. The strength of the connecting portions can be adjusted by selecting a suitable number of profile means 21, and it is of course ensured that the profile means are arranged at such angular intervals that the necessary fit of the connecting portions 6 is achieved.

All the above-described embodiments of inventive devices 10 for producing containers 1 are advantageous by allowing production of containers 1 from a single web-shaped container material 11. This material 11 is folded to form a folded web 17, after which opposing surfaces of the web 17 are sealed together along succeeding connecting portions 6. This eliminates the need of joining a plurality of material webs, which results in the necessary pattern alignment between the different walls 2, 3 of each container 1 being extremely simple. Furthermore the sealing process for forming said connecting portions 6 is performed at a sealing station 13, which is intended for continuous operation, thereby allowing an advantageously high production capacity.

It will be appreciated that the present invention is not restricted to the embodiments shown and that several modifications and variations are conceivable. The scope of the present invention is thus defined exclusively by the appended claims.

1. A container for liquid contents, comprising a compartment (4) which is defined by flexible walls (2, 3) and whose volume is dependent on the relative position of the walls (2, 3), the walls (2, 3) having rim portions which engage each other and along which the walls (2, 3) are joined with each other in a common connecting portion (6), characterized in
that the walls (2, 3) are made in one piece, which is folded to form said walls (2, 3), and
that the walls (2, 3) along said rim portions are sealed to form said connecting portion (6).

2. A container as claimed in claim 1, in which said piece is folded to form a container comprising two opposite side walls (2) and a bottom wall (3), by means of which the side walls (2) are connected with each other.

3. A method for producing containers (1), which each have a compartment (4) which is defined by flexible walls (2, 3) and whose volume is dependent on the relative position of the walls (2, 3), characterized by the steps of
converting a web-shaped container material (11) into a longitudinally folded web (17) having at least one fold (18) along one long side (19) of the folded web (17), sealing together opposing surfaces of the web (17) along succeeding connecting protions (6),
each connecting portion (6) forming a curve having a starting point and an end point along said at least one fold (18) and being of an extent which essentially corresponds to the shape of a finished container (1).

4. A method as claimed in claim 3, in which the opposing surfaces are sealed together in a continuous heat-sealing process.

5. A method as claimed in claim 3, in which the opposing surfaces are sealed together in a continuous ultrasonic sealing process.

6. A method as claimed in any one of claims 3-5, further comprising the step of removing the finished containers (1) from the web (17) along said connecting portions (6).

7. A method as claimed in claim 5, in which the containers (9) are removed from the web (17) in such a manner that the succeeding containers (1) are interconnected to form a web of containers (1).

8. A method as claimed in any one of claims 3, 4, 5 and 7, in which the step of converting the web-shaped container material (11) into a longitudinally folded web (17) comprises the measure of making a W-folded web (17) with two folds (18) which extend along said one long side (19) of the folded web (17), whereby the (17) obtains two opposite lateral portions and a central portion folded in two, which connects the two lateral portions with each other, each container (1) obtaining a side wall (2) from the respective lateral portions and a bottom wall (3) from the central portion.

9. A device for producing containers (1), which each have a compartment (4) defined by flexible walls (2, 3) and whose volume is dependent on the relative position of the walls (2, 3), characterized by
a folding station (12) for converting a web-shaped containing material (11) into a longitudinally folded web (17) having at least one fold (18) along one long side (19) of the folded web (17), and
a sealing station (13) which is adapted to seal together opposing surfaces of the web (17) along succeeding connecting portions (6), which each forma a curve which has a starting point and an end point along said at least one fold (18) and is of an extent which essentially corresponds to the shape of a finished container (1).

10. A device as claimed in claim 9, in which said folding station (13) is adapted to convert said container material (11) into a longitudinally W-folded web (17) with folds (18) which extend along said one said long side (19) of the folded web (17).

11. A device as claimed in claim 9 or 10, in which said sealing station (13) is adapted to seal together the opposing surfaces of the web (17) along succeeding connecting portions (6) in a continuous process.

12. A device as claimed in claim 11, in which said sealing station (13) comprises
a cylindrical profile means (21), on whose circumferential surface at least one projecting profile (23) is arranged, which is of an extent corresponding to the shape of a connecting portion (6),
a nip means (22) which forms a nip (24) with said profile means (21),
said at least one profile (23) of the profile means (21) being adapted, when inserting the folded web (17) into said nip (24), to engage with the folded web (17) and make the same abut against the nip means (22) to form said connecting portions (6).

13. A device as claimed in claim 12, in which the sealing station (13) further comprises a heating means for providing heat sealing in connection with the profile's (23) engagement with said folded web (17).

14. A device as claimed in claim 12, in which the nip means (22) comprises a roller means (26) abutting against the profile means (21).

15. A device as claimed in claim 12, in which the nip means (12) comprises at least one further roller means (26) abutting said profile means (21).

16. A device as claimed in claim 14, further comprising at least one further profile means (21), said roller means (26) also abutting against said further profile means (21).

17. A device as claimed in claim 12, in which said nip means (22) comprises an ultrasonic means (25) for providing ultrasonic sealing in connection with the profile's (21) engagement with said folded web (17).
